(19) United States
(12) Patent Application Publication
(10) Pub. No.: US 2025/0187952 A1
(43) Pub. Date: Jun. 12, 2025

(54) METHOD FOR OPERATING DEIONIZED WATER PRODUCTION SYSTEM AND DEIONIZED WATER PRODUCTION SYSTEM

(71) Applicant: ORGANO CORPORATION, Tokyo (JP)

(72) Inventors: Keisuke SASAKI, Tokyo (JP); Mayu ABE, Tokyo (JP); Atsushi NAGAYAMA, Tokyo (JP); Shogo KUSHIDA, Tokyo (JP)

(73) Assignee: ORGANO CORPORATION, Tokyo (JP)

(21) Appl. No.: 18/856,179

(22) PCT Filed: Mar. 13, 2023
(86) PCT No.: PCT/JP2023/009652

§ 371 Date: Oct. 11, 2024

(30) Foreign Application Priority Data
Apr. 15, 2022 (JP) 2022-067644

(51) Int. Cl. C02F 1/469; C02F 1/42; C02F 1/44

(52) U.S. Cl. CPC C02F 1/4695; C02F 1/42; C02F 1/441; C02F 2201/4614; C02F 2209/055; C02F 2209/40; C02F 2209/44

(57) ABSTRACT

A method for operating a deionized water production system for producing deionized water from water to be treated using an electrodeionization device includes: providing a water intake mode, in which the water to be treated is passed through a demineralization chamber of the electrodeionization device without energizing the electrodeionization device to obtain treated water, and a water intake and regeneration mode, which is operated alternately with the water intake mode and in which treated water is passed through the demineralization chamber to obtain treated water while the electrodeionization device is energized, and water is further passed through at least one of a concentration chamber and an electrode chamber of the electrodeionization device; and operating the electrodeionization device such that the operation time of the water intake mode is 1.5 to 6.4 times the operation time of the water intake and regeneration mode.

### TECHNICAL FIELD

The present invention relates to a method for operating a deionized water production system having an electrodeionized water production device and to the deionized water production system.

### BACKGROUND ART

Deionized water production systems are known in which water to be treated is passed through an ion exchanger such as an ion exchange resin to perform deionization through an ion exchange reaction. Such systems generally include a device having an ion exchanger and produce deionized water (e.g., pure water) by utilizing an ion exchange reaction caused by the ion exchanger. However, in a device having an ion exchanger, the ion exchange groups of the ion exchanger become saturated as the water to be treated passes through the device, causing a decrease in the deionization performance, and as a result, a process must be carried out to restore the deionization performance (hereinafter referred to as “regeneration”).

Known methods for regenerating an ion exchanger include periodically replacing the ion exchanger with a new one, periodically regenerating the ion exchanger using a chemical such as an acid or an alkali, and continuously regenerating the ion exchanger using an electrodeionization device (also called an EDI device).

The method of periodically replacing the ion exchanger has the problem that deionized water cannot be produced continuously because deionized water cannot be produced during the replacement operation. Furthermore, when producing deionized water at a high flow rate of water to be treated, the ion exchanger needs to be replaced relatively frequently, making the system unsuitable for producing deionized water when the flow rate of water to be treated is high. Furthermore, the method of periodically replacing the ion exchanger is undesirable because disposable of the ion exchanger increases waste.

Methods of regenerating ion exchangers using chemicals have the problems that these methods require chemicals such as acids or alkalis, and further, deionized water cannot be produced during regeneration, making it impossible to produce deionized water continuously.

In order to continuously produce deionized water in a method in which the ion exchanger is periodically replaced or a method in which a chemical is used, a method can be considered in which, for example, a current and a spare ion exchanger are prepared and used alternately. However, such a method requires an increased number of facilities for filling the ion exchangers and for injecting the chemicals required for regeneration.

An EDI device is configured such that a plurality of anion exchange membranes and cation exchange membranes are arranged between electrodes (anodes and cathodes) to form electrode chambers, concentration chambers, and demineralization chambers, these demineralization chambers being filled with ion exchangers (anion exchangers and cation exchangers). Water to be treated is supplied to the demineralization chamber, and the water (e.g., the water to be treated, deionized water) is supplied to the electrode chamber and the concentration chamber. The EDI device maintains deionization performance by applying a voltage between the electrodes to cause an electric current to flow that causes a water dissociation reaction that generate hydrogen ions (H⁺) and hydroxide ions (OH⁻), and these ions are then exchanged for ions attached to the ion exchanger in the demineralization chamber. Therefore, by using the EDI device, it is possible to continuously produce deionized water and regenerate the ion exchanger. Such an EDI device is described in, for example, Patent Document 1.

### PRIOR ART DOCUMENTS

### Patent Documents

Patent Document 1: WO 2018/117035 A1

### SUMMARY OF INVENTION

### Problem to be Solved by Invention

In order to prevent deterioration of the quality of deionized water (treated water) due to a decrease in deionization performance, the EDI device is usually kept energized at all times during operation. Therefore, a deionized water production system equipped with an EDI device has the problem of high power consumption. During operation, water to be treated is supplied to the demineralization chamber, and water is also supplied to the concentration chamber and the electrode chamber, thereby producing deionized water in the demineralization chamber, while concentrated liquid containing ions that have migrated from the demineralization chamber is discharged from the concentration chamber, and electrode water is discharged from the electrode chamber. Therefore, there is also a problem that the EDI device entails a large amount of wastewater.

The present invention has been made to solve the problems inherent in the background art as described above and has an object of providing a method for operating a deionized water production system and a deionized water production system that can reduce both power consumption and amount of wastewater of an electrodeionization device while also preventing deterioration of the water quality of treated water.

### Means for Solving Problem

In order to achieve the above objects, a method for operating a deionized water production system according to the present invention is a method for operating a deionized water production system for producing deionized water from water to be treated using an electrodeionization device, comprising steps of:

providing a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is further passed through the demineralization chamber to obtain treated water while the electrodeionization device is energized, and water is passed through at least one of a concentration chamber and an electrode chamber of the electrodeionization device; and

operating the electrodeionization device such that the operation time of the water intake mode is 1.5 to 6.4 times the operation time of the water intake and regeneration mode.

Alternatively, a method for operating a deionized water production system according to the present invention is a method for operating a deionized water production system for producing deionized water from water to be treated using an electrodeionization device, comprising steps of:

providing a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized, and water is further passed through at least one of a concentration chamber and an electrode chamber of the electrodeionization device; and

operating the electrodeionization device in the water intake mode and the water intake and regeneration mode such that a load factor calculated by the formula:

$$load factor ( \% ) = ( Q \div G ) \times 100$$

is within the range from 10 to 31%, where:

$$Q [ meq ] = \{ ( C - 0.55 ) \div 126.46 \} \times P \times T 1 \\ and \\ G [ meq ] = I \times 3600 \times T 2 \div F \times 1000$$

and where: Q [meq] is a load inflow per day; P [L/h] is a treatment flow rate per demineralization chamber; T1 [h] is a water flow operation time per day, which is the total time during which the electrodeionization device is energized and the electrodeionization device is not energized; C [μS/cm] is the conductivity of water to be treated; G [meq] is the amount of regenerant produced per day by energizing the electrodeionization device; T2 [h] is the total time per day during which the electrodeionization device is energized; I [A] is the current applied; and F [C/eq]=96485 is the Faraday constant.

In addition, a deionized water production system of the present invention comprises:

an electrodeionization device for producing deionized water from water to be treated;

a power supply device that applies a required DC voltage to the electrodeionization device; and

a control device that provides a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized and water is further passed through at least one of a concentration chamber and an electrode chamber of the electrodeionization device, and that further operates the electrodeionization device such that the operation time of the water intake mode is 1.5 to 6.4 times the operation time of the water intake and regeneration mode.

Alternatively, a deionized water production system of the present invention, comprises:

an electrodeionization device for producing deionized water from water to be treated;

a power supply device that applies a required DC voltage to the electrodeionization device; and

a control device that provides a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized and water is further passed through at least one of a concentration chamber and an electrode chamber of the electrodeionization device, and that further operates the electrodeionization device in the water intake mode and the water intake and regeneration mode such that a load factor calculated by the formula:

$$load factor ( \% ) = ( Q \div G ) \times 100$$

is within the range from 10 to 31%, where:

$$Q [ meq ] = \{ ( C - 0.55 ) \div 126.46 \} \times P \times T 1 \\ and \\ G [ meq ] = I \times 3600 \times T 2 \div F \times 1000$$

and where: Q [meq] is a load inflow per day; P [L/h] is a treatment flow rate per demineralization chamber; T1 [h] is a water flow operation time per day, which is the total time during which the electrodeionization device is energized and the electrodeionization device is not energized; C [μS/cm] is the conductivity of water to be treated; G [meq] is the amount of regenerant produced per day by energizing the electrodeionization device; T2 [h] is the total time per day during which the electrodeionization device is energized; I [A] is the current applied; and F [C/eq]=96485 is the Faraday constant.

### Effect of Invention

According to the present invention, the power consumption and the amount of wastewater of an electrodeionization device can be reduced while preventing deterioration of the water quality of treated water.

### BRIEF DESCRIPTION OF DRAWINGS

FIG. 1 is a block diagram showing an example of the configuration of a deionized water production system according to the present invention;

FIG. 2 is a schematic diagram showing an example of the configuration of the electrodeionization device shown in FIG. 1;

FIG. 3 is a schematic diagram showing another example of the configuration of the electrodeionization device shown in FIG. 1;

FIG. 4 is a schematic diagram showing another example of the configuration of the electrodeionization device shown in FIG. 1;

FIG. 5 is a graph showing the change in current efficiency and the conductivity of treated water versus regeneration time of an ion exchanger;

FIG. 6 is a graph showing changes in water quality of treated water over one day under the first to fifth conditions and the comparative example shown in Table 1;

FIG. 7 is a graph showing the change in power consumption over one day under the first to fifth conditions and the comparative example shown in Table 1;

FIG. 8 is a graph showing the relationship between the conductivity of treated water and the ratio of the energized time to the non-energized time of the EDI device shown in Table 2;

FIG. 9 is a graph showing the relationship between the power consumption reduction rate shown in Table 1 and the ratio of the energized time to the non-energized time of the EDI device shown in Table 2;

FIG. 10 is a graph showing the relationship between the load factor shown in Table 3 and the conductivity of treated water;

FIG. 11 is a graph showing the relationship between the load factor shown in Table 3 and the reduction rate of power consumption shown in Table 1;

FIG. 12 is a graph showing the relationship between the conductivity of treated water and the ratio of the energized time to the non-energized time of the EDI device shown in Table 2; and

FIG. 13 is a graph showing the relationship between the load factor shown in Table 3 and the conductivity of treated water.

### DESCRIPTION OF EMBODIMENTS

Next, the present invention will be described with reference to the drawings. The inventors have found that when regenerating an ion exchanger in an EDI device, the efficiency of power utilization for regeneration is improved when the proportion of the salt form of the ion exchanger is high. In view of this, in this embodiment, a method is proposed in which deionized water is produced without energizing the EDI device (non-energized) until the proportion of the salt form of the ion exchanger increases, following which the EDI device is energized to begin operation once the proportion of the salt form has increased to a certain extent. Furthermore, the inventors have discovered that by producing deionized water by passing the water to be treated only through the demineralization chamber and not through the concentration chamber or electrode chamber of the EDI device when the EDI device is not energized, not only can deionized water be obtained of the same quality as when the EDI device is operated continuously while current is applied, but power consumption and the amount of wastewater can also be reduced. There is no reason why water should not be passed through the concentration chamber and the electrode chamber of the EDI device when electricity is not being supplied, and water may be passed through the concentration chamber and the electrode chamber when electricity is not being supplied. In addition, the term “non-energized” used here indicates a state in which the water dissociation reaction does not proceed within the EDI device, and also includes a state in which a weak voltage is applied between the electrodes for purposes such as preventing ion diffusion from the concentration chamber to the demineralization chamber. For example, since the theoretical voltage required for dissociation of water is 0.83 V, a voltage of 0.83 V or less may be applied to each demineralization chamber.

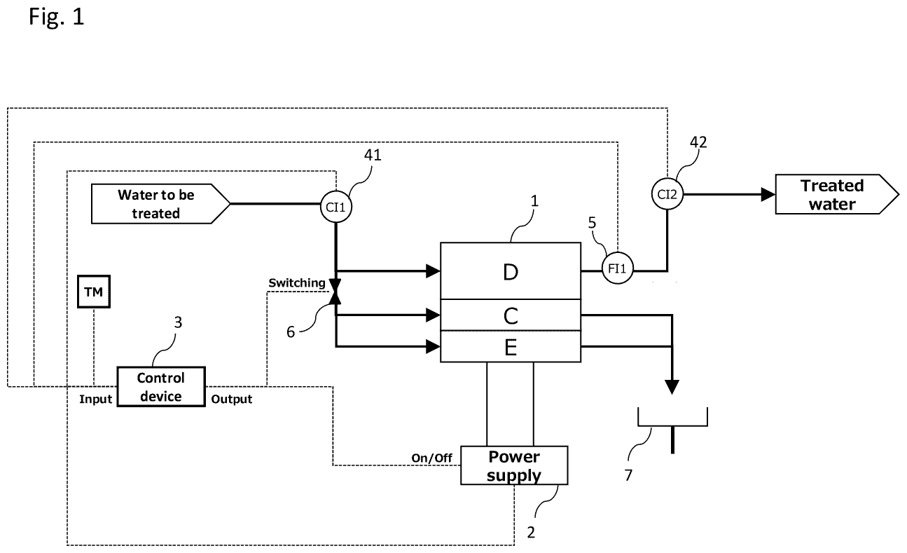

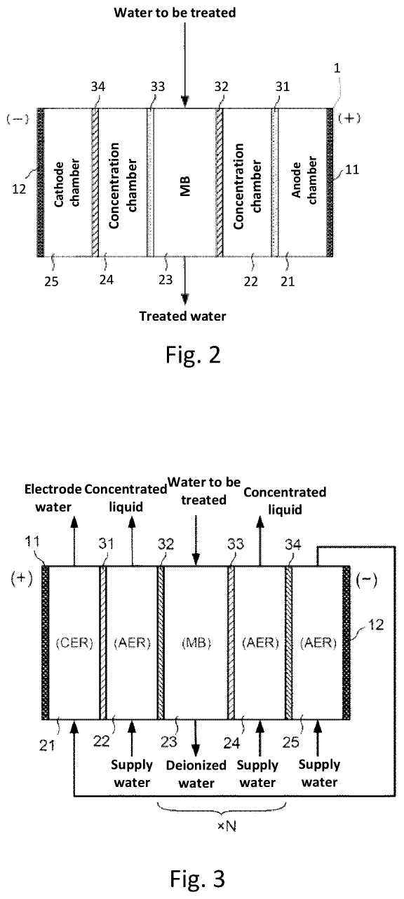

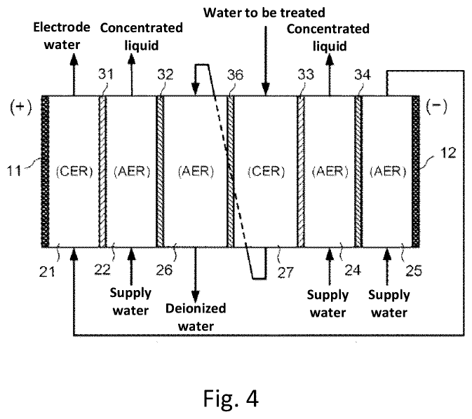

FIG. 1 is a block diagram showing an example of the configuration of a deionized water production system according to the present invention. FIG. 2 is a schematic diagram showing an example of the configuration of the electrodeionization device shown in FIG. 1. FIGS. 3 and 4 are schematic diagrams showing another example of the configuration of the electrodeionization device shown in FIG. 1. FIGS. 2 to 4 show the configuration disclosed in the above-mentioned Patent Document 1.

As shown in FIG. 1, the deionized water production system of the present invention comprises electrodeionization device (EDI device) 1 that produces deionized water from water to be treated, power supply unit 2 that applies to EDI device 1 a required DC voltage necessary to maintain the deionization performance, and control device 3 that controls the operation of the entire deionized water production system. The water to be treated is sent to demineralization chamber (D) of EDI device 1 via a pump (not shown), and demineralization chamber (D) produces treated water (deionized water). The conductivities of the water to be treated and the treated water are measured using well-known conductivity meters 4 (41 and 42) to determine the water quality. The discharge amount (production amount) of treated water from demineralization chamber (D) of EDI device 1 is measured using a known flow meter (integrating flow meter) 5. Control device 3 is connected to conductivity meters 4 and flow meter 5 via known communication means, and data are transmitted on the conductivities of the water to be treated and the treated water as well as data on the production amount of treated water. Furthermore, valve 6 controls the supply and shutting off of water to be treated to the concentration chamber (C) and the electrode chamber (E) of EDI device 1. The concentrated liquid discharged from the concentration chamber (C) and the electrode water discharged from the electrode chamber are each discharged into drain tank 7.

Control device 3 is connected to power supply device 2, the pump, and valve 6 via known communication means and is capable of controlling the operations of power supply device 2, the pump and valve 6. Control device 3 effects on/off control of power supply device 2 and also uses the pump and valve 6 to control the supply and shut-off of water to be treated to demineralization chamber (D) of EDI device 1 as well as to control the supply and shut-off of water to be treated to concentration chamber (C) and electrode chamber (E) of EDI device 1. Control device 3 also includes a timer and controls the operation time of EDI device 1 in each of two operation modes (the water intake mode and the water intake and regeneration mode) to be described below. The communication means between control device 3 and power supply device 2, the pump, valve 6, conductivity meters 4, and flow meter 5 may be any well-known wired communication means or wireless communication means, and any well-known communication standard may be used.

Control device 3 can be realized by, for example, a well-known Programmable Logic Controller (PLC). Control device 3 may be realized by a known information processing device (computer) including a Central Processing Unit (CPU), a storage device, an I/O interface, a communication device, and the like. Control device 3 realizes the operation method of the deionized water production system of the present invention by having a processor in the PLC or information processing device execute processing according to a program stored in advance in the storage device.

Although not shown in FIG. 1, to obtain deionized water with a sufficiently reduced impurity concentration, the deionized water production system of the present invention may be equipped with a reverse osmosis membrane device that includes a well-known reverse osmosis membrane (RO membrane) upstream of EDI device 1. The deionized water production system may include multiple stages (e.g., two stages) of reverse osmosis membrane devices that are connected in series. When a two-stage reverse osmosis membrane device is provided, raw water stored in a storage tank or the like is passed through the first-stage reverse osmosis membrane device, the permeated water is passed through the second-stage reverse osmosis membrane device, and the permeated water from the second-stage reverse osmosis membrane device is sent to the demineralization chamber of the EDI device 1 as the water to be treated. The reverse osmosis membrane device may be configured to include a general reverse osmosis membrane used, for example, for producing pure water.

As shown in FIG. 2, EDI device 1 has a configuration in which multiple pairs of cation exchange membranes and anion exchange membranes (two pairs in FIG. 2) are arranged between two electrodes (anode 11 and cathode 12) to form electrode chambers 21 and 25, concentration chambers 22 and 24, and demineralization chamber 23. Electrode chamber (anode chamber) 21 is formed by anode 11 and cation exchange membrane 31, and electrode chamber (cathode chamber) 25 is formed by cathode 12 and anion exchange membrane 34. Demineralization chamber 23 is formed by anion exchange membrane 32 and cation exchange membrane 33, and two concentration chambers 22 and 24 are formed with demineralization chamber 23 between them. Concentration chamber 22 on the anode-11 side is formed by cation exchange membrane 31 and anion exchange membrane 32, and concentration chamber 24 on cathode-12 side is formed by cation exchange membrane 33 and anion exchange membrane 34. Demineralization chamber 23 is filled with an ion exchanger (MB) which is a mixture of a cation exchanger and an anion exchanger. Electrode chambers 21 and 25 and the concentration chambers 22 and 24 may be filled with an ion exchanger as appropriate.

As shown in FIG. 3, EDI device 1 may also have a configuration in which multiple basic components (cell sets) consisting of concentration chamber 22, demineralization chamber 23, and concentration chamber 24 shown in FIG. 2 are arranged side by side between anode 11 and cathode 12. In this case, adjacent concentration chambers can be shared between adjacent cell sets. FIG. 3 shows an example of a configuration in which N (N is an integer of 1 or more) cell sets are arranged between anode 11 and cathode 12. In EDI device 1 shown in FIG. 3, anode chamber 21 is filled with a cation exchanger (CER), concentration chambers 22 and 24 and cathode chamber 25 are filled with an anion exchanger (AER), and demineralization chamber 23 is filled with an ion exchanger (MB) which is a mixture of a cation exchanger and an anion exchanger. Furthermore, EDI device 1 shown in FIG. 3 is configured such that water is not supplied to anode chamber 21 from the outside, but outlet water of cathode chamber 25 is supplied to anode chamber 21.

As shown in FIG. 4, EDI device 1 may also have a configuration in which two demineralization chambers 26 and 27 are formed by disposing intermediate ion exchange membrane 36 between two concentration chambers 22 and 24. In EDI device 1 shown in FIG. 4, demineralization chamber 26 is filled with an anion exchanger (AER), and demineralization chamber 27 is filled with a cation exchanger (CER). The water to be treated is passed through demineralization chamber 27 and then through demineralization chamber 26. The types and amounts of ion exchangers placed in the two demineralization chambers 26 and 27 do not need to be the same. For example, one demineralization chamber may be filled with a cation exchanger and an anion exchanger, and the other demineralization chamber may be filled with only a cation exchanger. Alternatively, one demineralization chamber may be filled with a cation exchanger and an anion exchanger, and the other demineralization chamber may be filled with only an anion exchanger.

EDI device 1 may also be configured such that the ion exchanger (anion exchange membrane 34 or cation exchange membrane 31) that separates an electrode chamber from a concentration chamber is eliminated, thereby forming a chamber serving both as a concentration chamber and an electrode chamber.

In this configuration, the operating modes of EDI device 1 in this embodiment include a water intake mode, in which the water to be treated is passed through demineralization chamber (D) without energizing the EDI device to obtain treated water, and a water intake and regeneration mode, in which the water to be treated is passed through demineralization chamber (D) while the EDI device is energized to obtain treated water and supply water is further passed through the concentration chamber (C) and the electrode chamber (E) to regenerate the ion exchanger.

For example, to obtain treated water of the quality of A1 water used in the testing of water and wastewater as specified in the Japanese Industrial Standards (JIS K 0557) or Type IV water quality (5 μS/cm (0.5 mS/m)) as specified in the ASTM standard for standard specification for reagent water, the operation time of the water intake mode should preferably be set within the range from 1.5 to 6.4 times the operation time of the water intake and regeneration mode. Furthermore, to obtain treated water of better water quality (1 μS/cm (0.1 mS/m)) as specified in the above-mentioned Japanese Industrial Standards (JIS K 0557), the operation time of the water intake mode should more preferably be set within the range from 1.5 to 4.0 times the operation time of the water intake and regeneration mode. The lower limit of 1.5 times is determined based on the power consumption reduction rate, which will be described later.

The operation times of the water intake mode and the water intake and regeneration mode may be determined as follows. For example, to obtain treated water of the standard specification water quality (5 μS/cm (0.5 mS/m)), the operation times of the water intake mode and the water intake and regeneration mode are set so that the load factor calculated below is within the range from 10 to 31%. Alternatively, to obtain treated water of better water quality (1 μS/cm (0.1 mS/m)) as specified in the above-mentioned Japanese Industrial Standard (JIS K 0557), the operation times of the water intake mode and the water intake and regeneration mode are set so that the load factor calculated below is within the range from 10 to 20%.

$$Load rate ( \% ) = ( load inflow amount in one day \div amount of \\ regerant produced by energization in one day ) \times 100.$$

Here, assuming that: the load inflow per day is Q [meq]; the treatment flow rate per demineralization chamber is P [L/h]; the water flow operation time per day, which is the total time during which the electrodeionization device is energized and the electrodeionization device is not energized is T1 [h]; the conductivity of water to be treated is C [μS/cm]; the amount of regenerant produced per day by energizing the electrodeionization device is G [meq]; the total time per day during which the electrodeionization device is energized is T2 [h]; the current applied is | [A]; and the Faraday constant is F [C/eq]=96485, Q and G are calculated as follows:

$$Q [ meq ] = \{ ( C - 0.55 ) \div 126.46 \} \times P \times T 1 \\ G [ meq ] = I \times 3600 \times T 2 \div F \times 1000.$$

The load inflow amount in one day, i.e., Q, is calculated by subtracting the conductivity of pure water from the conductivity of water to be treated and converting the remaining conductivity into milliequivalents (meq) using the limiting molar conductivity of NaCl. The amount of regenerant produced by energization in one day, i.e., G, is calculated by converting the value of the energizing current into an amount of electricity and then converting the amount of electricity into milliequivalents using the Faraday constant.

The water to be treated that is passed through EDI device 1 is preferably water with a low concentration of components that may precipitate due to retention in the concentration chamber during operation in the water intake mode. The water to be treated preferably has an ionic silica concentration of 150 μg/L or less and a hardness (calcium/magnesium concentration) of 100 μg CaCO3/L or less.

Incidentally, intermittent operation of EDI device 1 is also described in, for example, JP 2017-56384 A (Patent Document 2). However, Patent Document 2 points out that if the operation of EDI device 1 is stopped when the required amount of treated water has been obtained, the amount of boron in the treated water will increase. Patent Document 2 therefore proposes an operating method for maintaining the boron removal rate. Patent Document 2 is not directed at reducing power consumption and the amount of wastewater while suppressing deterioration of the water quality of the treated water, as in the present invention, and its operating method differs entirely from that of the deionized water production system of the present invention.

### EXAMPLES

Next, examples of the present invention will be described.

In the examples, EDI device 1 in the deionized water production system shown in FIG. 1 is operated by controlling the operation times of each of the water intake mode and the water intake and regeneration mode. The examples show that the power consumption and the amount of wastewater of EDI device 1 can be reduced while suppressing deterioration of the water quality of treated water.

### First Example

In the first example, a salt form (chloride ion form) ion exchange resin was prepared as the anion exchanger. This anion exchanger fills the demineralization chamber of EDI device 1 together with a regenerated cation exchange resin. When the ion exchanger is regenerated by passing pure water through each of the demineralization chamber, concentration chamber, and electrode chamber, the proportion of the current used to discharge chloride ions (regenerate the ion exchange resin) was calculated from the concentration of chloride ions discharged as concentrated liquid relative to the amount of electricity that energizes EDI device 1 (i.e., the current efficiency), and this efficiency was graphed. The graph also shows the progression of the water quality of treated water based on the measurement results of the conductivity.

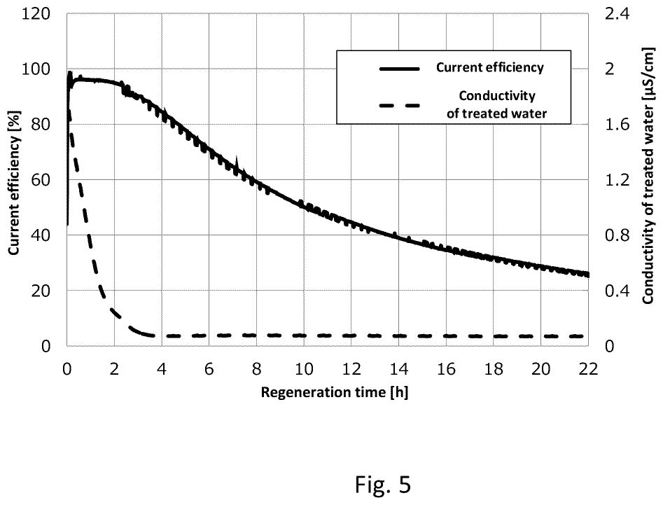

FIG. 5 is a graph showing the change in current efficiency and the change in the conductivity of treated water versus the regeneration time of the ion exchanger. The lower the conductivity, the smaller the amount of ions contained. In other words, lower values indicate better water quality.

As shown in FIG. 5, the current efficiency can be kept at a high efficiency of 90% or more for about two hours after the start of energizing electricity EDI device 1, but thereafter the efficiency gradually decreases, reaching 50% or less after 10 hours. Measurements confirmed that the above-mentioned conductivity of 1 μS/cm or less, which indicates the water quality of treated water, can be achieved in about one hour after the start of energizing EDI device 1.

Therefore, the current efficiency of EDI device 1 is understood to be higher when the device is operated in a state in which the proportion of the salt form of the ion exchanger is high. Testing also showed that setting the time of one energization of EDI device 1, that is, the operation time in the water intake and regeneration mode, to 2 hours or more enables operation with relatively good water quality (low conductivity). However, as mentioned above, since the current efficiency drops to 50% or less after 10 hours, the time of one operation of the water intake and regeneration mode by EDI device 1 is preferably 10 hours or less.

### Second Example

In the second example, EDI device 1 is operated under the first to fifth conditions shown in Table 1 below, and the changes in power consumption and quality of treated water are compared. Table 1 also shows data for a comparative example (“Comparative” in Table 1) in which EDI device 1 was operated continuously.

TABLE 1

| | | Number of | Total | | | Amount of | | | |
|---|---|---|---|---|---|---|---|---|---|
| | | [symbol] | duration of | [symbol] | Amount of | water | Water | Reduction Rate | |
| | Duration of | per day | energization | consumption | [symbol] | production | production | | [symbol] |
| | one [symbol] | [symbol] Number of | per day | [symbol] day | per day | per day | [symbol] | | consumption |
| [symbol] | [symbol] | times/day [symbol] | [ [symbol] /day] | [symbol] /day [symbol] | [symbol] /day [symbol] | [symbol] /day [symbol] | [%] | [symbol] | [symbol] |
| 1 | 5 | 1 | 5 | 1008 | [symbol] | 48000 | [symbol] | −79% | −75% |
| 2 | 7 | 1 | 7 | 1794 | [symbol] | 48000 | 96.3% | −71% | [symbol] |
| 3 | 2.33 | 3 | 7 | [symbol] | [symbol] | 48000 | 96.4% | −71% | [symbol] |
| 4 | 1.17 | 6 | 7 | 1901 | 1825 | 48000 | [symbol] | −71% | [symbol] |
| 5 | 2.17 | 6 | [symbol] | 4894 | [symbol] | 48000 | [symbol] | [symbol] | [symbol] |
| Comparative | 24 | 1 | 24 | 4032 | 6240 | 48000 | 88.5% | — | — |

[symbol]

indicates data missing or illegible when filed

In the second example, EDI device (EDI-HF2-1000) 1 manufactured by Organo Corporation was used, and the amount of water to be treated passing through the demineralization chamber (D) was set to 2000 L/h, the amount of water supplied through the concentration chamber (C) during operation in the water intake and regeneration mode was set to 240 L/h, and the amount of water supplied through the electrode chamber (E) was set to 20 L/h. During operation in the water intake and regeneration mode, EDI device 1 was set to a constant current operation of DC 2.5 A. Permeated water having a conductivity of 2.5±0.2 μS/cm that had permeated two stages of reverse osmosis membrane devices connected in series was supplied to the demineralization chamber (D) of EDI device 1. Table 1 shows the operation data per day following stabilization of the data after operation for two or more days under the first to fifth conditions.

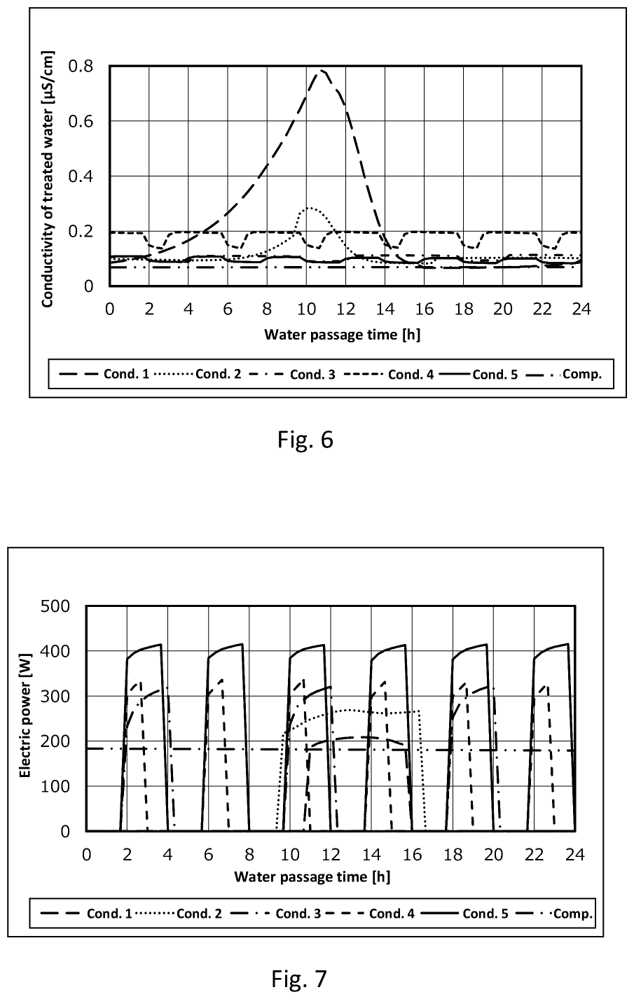

FIG. 6 is a graph showing changes in water quality of treated water over one day under the first to fifth conditions along with the comparative example shown in Table 1. FIG. 7 is a graph showing the change in power consumption over one day under the first to fifth conditions along with the comparative example shown in Table 1.

As shown in FIG. 6, the conductivity of treated water can be seen to have decreased when the device was operated in the water intake and regeneration mode, and the conductivity of treated water increased when the device was operated in the water intake mode. Under the first condition, in which the system was operated for only five hours per day, the conductivity can be seen to have increased significantly (the water quality deteriorates significantly). On the other hand, the water quality tended to be relatively stable under the third to fifth conditions. However, compared to the comparative example shown in Table 1 in which operation proceeded continuously for 24 hours in the water intake and regeneration mode, the power consumption was seen to be higher under the fifth condition than in the comparative example.

The second to fourth conditions had the same total energized time per day (7 hours), but as shown in FIG. 6, the changes in the water quality (conductivity) of treated water were different, with the third condition being stable and producing the best water quality (lowest conductivity). For this reason, the energized time per cycle (time of operation in the water intake and regeneration mode) should be set to 2 hours or more. The fifth condition also required an energized time (time of operation in the water intake and regeneration mode) of 2 hours or more per cycle, and the water quality (conductivity) of treated water was relatively good, but as described above, power consumption was high. The third condition and the fifth condition differed regarding the number of times the water intake and regeneration mode was operated per day: 3 times in the third condition and 6 times in the fifth condition. That is, even if the quality of the treated water was the same, increasing the number of times the water intake and regeneration mode was operated increased the amount of wastewater and power consumption.

Table 2 shows the ratio of the energized time to the non-energized time (non-energized time/energized time) of EDI device 1 under the first to fifth conditions and the comparative example shown in Table 1. Table 3 shows the above-mentioned load factor under the first to fifth conditions and the comparative example shown in Table 1. The energized time is the time of operation in the water intake and regeneration mode, and the non-energized time is the time of operation in the regeneration mode.

TABLE 2

| | Energized time: Non- |
|---|---|
| Condition | energized time |
| 1 | 1:3.8 |
| 2 | 1:2.4 |
| 3 | 1:2.4 |
| 4 | 1:2.4 |
| 5 | 1:0.8 |
| Comparative | 1:0.0 |

TABLE 3

| Condition | Load factor [%] |
|---|---|
| 1 | 19.9 |
| 2 | 14.2 |
| 3 | 14.2 |
| 4 | 14.2 |
| 5 | 7.6 |
| Comparative | 4.1 |

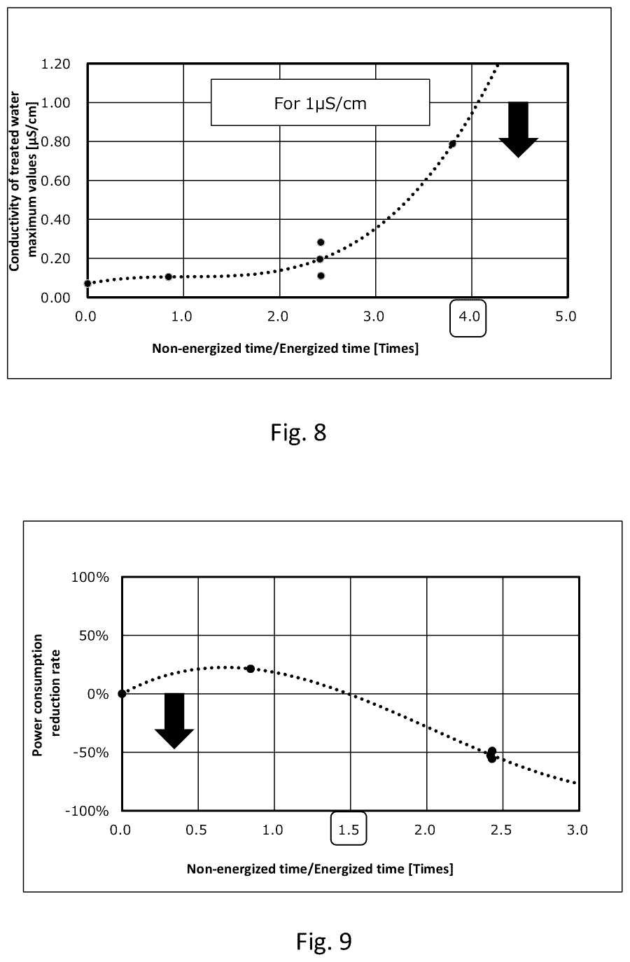

FIG. 8 is a graph showing the relationship between the conductivity of treated water (maximum value in one day) and the ratio of the energized time to the non-energized time (non-energized time/energized time) of the EDI device shown in Table 2. FIG. 9 is a graph showing the relationship between the power consumption reduction rate shown in Table 1 and the ratio of the energized time to the non-energized time (non-energized time/energized time) of the EDI device shown in Table 2.

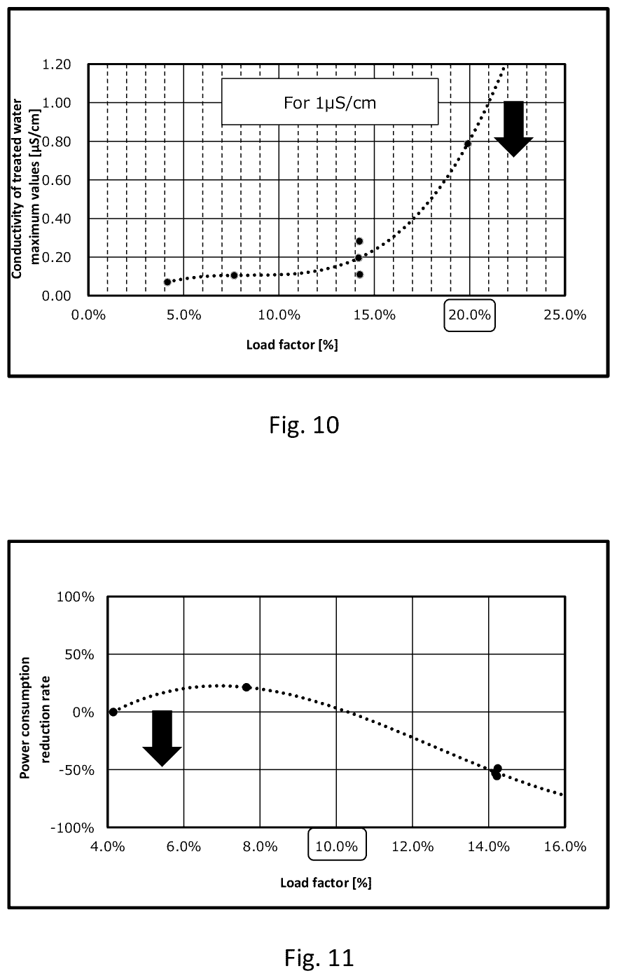

FIGS. 8 and 9, as well as the graphs of FIGS. 10 to 13 to be described later, show the maximum values calculated under the conditions shown in Tables 1 to 3 extended using approximated curves.

As can be seen from FIG. 8, for example, to obtain treated water having a conductivity of 1 μS/cm, the ratio of the energized time to the non-energized time of EDI device 1 (non-energized time/energized time) should be set to 4.0 times or less. Furthermore, as shown in FIG. 9, to reduce the power consumption reduction rate of EDI device 1 to 0% or less, that is, to achieve a greater reduction of power consumption than the above-mentioned comparative example, the ratio of the energized time to the non-energized time of EDI device 1 (non-energized time/energized time) should be set to 1.5 times or more.

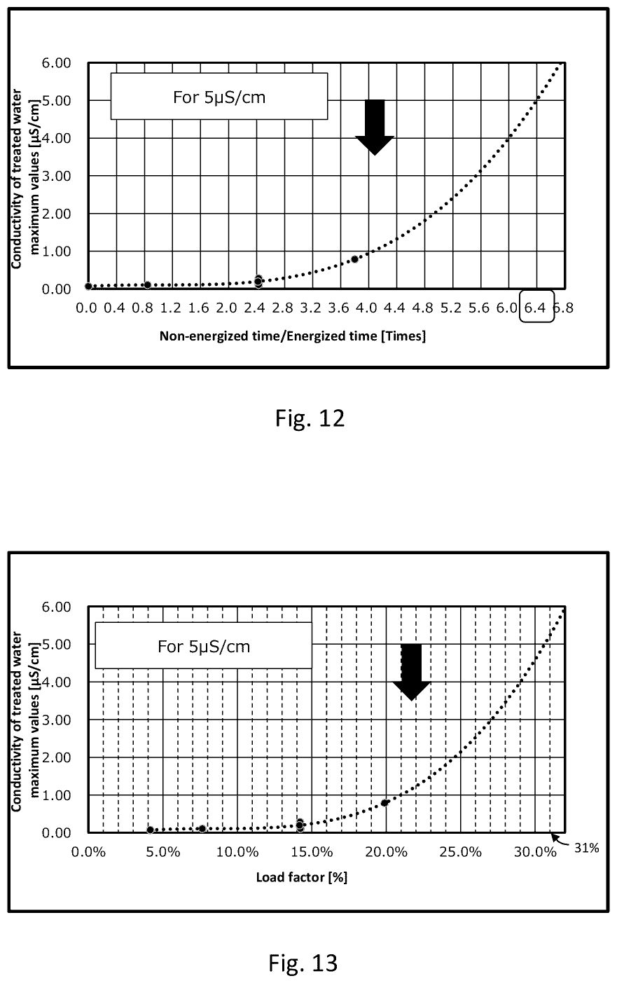

FIG. 10 is a graph showing the relationship between the load rate shown in Table 3 and the conductivity of treated water. FIG. 11 is a graph showing the relationship between the load factor shown in Table 3 and the reduction rate of power consumption shown in Table 1. FIG. 12 is a graph showing the relationship between the ratio of energized time to the non-energized time (non-energized time/energized time) of EDI device 1 shown in Table 2 and the conductivity of treated water. FIG. 13 is a graph showing the relationship between the load rate shown in Table 3 and the conductivity of treated water. FIG. 12 shows an approximation curve from the maximum value of the graph shown in FIG. 8, which is further extended. FIG. 13 shows an approximation curve from the maximum value of the graph shown in FIG. 10, in which the approximation curve is further extended.

As can be seen from FIG. 10, for example, to obtain treated water with the above-mentioned conductivity of 1 μS/cm, the load rate should be 20% or less. Furthermore, as can be seen from FIG. 11, to reduce the power consumption reduction rate of EDI device 1 to 0% or less, that is, to achieve a greater reduction of power consumption than that of the above-mentioned comparative example, the load factor should be 10% or more.

As can be seen from FIG. 12, for example, to obtain treated water with a conductivity of the above-mentioned 5 μS/cm, the ratio of the energized time to the non-energized time of EDI device 1 (non-energized time/energized time) should be set to 6.4 times or less. Also, as can be seen from FIG. 13, for example, to obtain treated water with the above-mentioned conductivity of 5 μS/cm, the load factor should be set to 31% or less.

In other words, to obtain treated water with a conductivity of the above 5 μS/cm, the operation time (non-energized time) in the water intake mode should be set to 1.5 to 6.4 times the operation time (energized time) in the water intake and regeneration mode. Furthermore, to obtain treated water having a conductivity of the above 1 μS/cm, the operation time (non-energized time) in the water intake mode should be set within the range from 1.5 to 3.8 times, and more preferably from 1.5 to 2.4 times, the operation time (energized time) in the water intake and regeneration mode.

Alternatively, to obtain treated water having a conductivity of the above-described 5 μS/cm, the water intake mode (non-energized time) and the water intake and regeneration mode (energized time) should be set such that the load factor is within the range from 10 to 31%. Furthermore, to obtain treated water having a conductivity of the above 1 μS/cm, the water intake mode (non-energized time) and the water intake and regeneration mode (energized time) should be set such that the load factor is within the range from 10 to 20%.

As described above, according to the present invention, there are provided a water intake mode, in which treated water is obtained by passing the water to be treated through the demineralization chamber (D) without energizing EDI device 1, and a water intake and regeneration mode, in which treated water is obtained by passing the water to be treated through the demineralization chamber while energizing EDI device 1, and supply water is further passed through the concentration chamber (C) and the electrode chamber (E) to maintain the deionization performance of the ion exchanger. By setting the operation time (non-energized time) of the water intake mode in the range from 1.5 to 6.4 times the operation time (energized time) of the water intake and regeneration mode, or by setting the water intake mode (non-energized time) and the water intake and regeneration mode (energized time) such that the load factor is within the range from 10 to 31%, the power consumption and wastewater amount of EDI device 1 can be reduced while suppressing deterioration of the water quality of treated water.

In this case, to obtain treated water of better quality (conductivity of the above 1 μS/cm), the operation time (non-energized time) of the water intake mode may be set within the range from 1.5 to 4.0 times the operation time (energized time) of the water intake and regeneration mode, or the water intake mode (non-energized time) and the water intake and regeneration mode (energized time) may be set such that the load factor is within the range from 10 to 20%.

1. A method for operating a deionized water production system for producing deionized water from water to be treated using an electrodeionization device, comprising:
providing a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is further passed through the demineralization chamber to obtain treated water while the electrodeionization device is energized, and water is passed through at least one of a concentration chamber and an electrode chamber of the electrodeionization device; and
operating the electrodeionization device such that the operation time of the water intake mode is 1.5 to 6.4 times the operation time of the water intake and regeneration mode.

2. A method for operating a deionized water production system for producing deionized water from water to be treated using an electrodeionization device, comprising:
providing a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized, and water is further passed through at least one of a concentration chamber and an electrode chamber of the electrodeionization device; and
operating the electrodeionization device in the water intake mode and the water intake and regeneration mode such that a load factor calculated by the formula:
$$load factor ( \% ) = ( Q \div G ) \times 100$$
is within the range from 10 to 31%, where:
$$Q [ meq ] = \{ ( C - 0.55 ) \div 126.46 \} \times P \times T 1 \\ and \\ G [ meq ] = I \times 3600 \times T 2 \div F \times 1000$$
and where: Q [meq] is a load inflow per day; P [L/h] is a treatment flow rate per demineralization chamber; T1 [h] is a water flow operation time per day, which is the total time during which the electrodeionization device is energized and the electrodeionization device is not energized; C [μS/cm] is the conductivity of water to be treated; G [meq] is the amount of regenerant produced per day by energizing the electrodeionization device; T2 [h] is the total time per day during which the electrodeionization device is energized; I [A] is the current applied; and F [C/eq]=96485 is the Faraday constant.

3. The method for operating the deionized water production system according to claim 1, wherein the operation time for each of said water intake and regeneration modes is 2 hours or more.

4. The method for operating the deionized water production system according to claim 1, wherein permeated water that has permeated a reverse osmosis membrane device is passed through the demineralization chamber as the water to be treated.

5. The method for operating the deionized water production system according to claim 1, wherein the ionic silica concentration of the water to be treated is 150 μg/L or less and the hardness (calcium/magnesium concentration) is 100 μg CaCO3/L or less.

6. A deionized water production system comprising:
an electrodeionization device for producing deionized water from water to be treated;
a power supply device that applies a required DC voltage to the electrodeionization device; and
a control device that provides a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized and water is further passed through at least one of a concentration chamber and an electrode chamber of the electrodeionization device, and that further operates the electrodeionization device such that the operation time of the water intake mode is 1.5 to 6.4 times the operation time of the water intake and regeneration mode.

7. A deionized water production system comprising:
an electrodeionization device for producing deionized water from water to be treated;
a power supply device that applies a required DC voltage to the electrodeionization device; and
a control device that provides a water intake mode, in which the water to be treated is passed through a demineralization chamber of the electrodeionization device without energizing the electrodeionization device to obtain treated water, and a water intake and regeneration mode, which is operated alternately with the water intake mode and in which the water to be treated is passed through the demineralization chamber to obtain treated water while the electrodeionization device is energized and water is further passed through at least one of a concentration chamber and an electrode chamber of the electrodeionization device, and that further operates the electrodeionization device in the water intake mode and the water intake and regeneration mode such that a load factor calculated by the formula:
$$load factor ( \% ) = ( Q \div G ) \times 100$$
is within the range from 10 to 31%, where:
$$Q [ meq ] = \{ ( C - 0.55 ) \div 126.46 \} \times P \times T 1 \\ and \\ G [ meq ] = I \times 3600 \times T 2 \div F \times 1000$$
and where: Q [meq] is a load inflow per day; P [L/h] is a treatment flow rate per demineralization chamber; T1 [h] is a water flow operation time per day, which is the total time during which the electrodeionization device is energized and the electrodeionization device is not energized; C [μS/cm] is the conductivity of water to be treated; G [meq] is the amount of regenerant produced per day by energizing the electrodeionization device; T2 [h] is the total time per day during which the electrodeionization device is energized; I [A] is the current applied; and F [C/eq]=96485 is the Faraday constant.

8. The deionized water production system according to claim 6, wherein the operation time for each of said water intake and regeneration modes is two hours or more.

9. The deionized water producing system according to claim 6, further comprising a reverse osmosis membrane device which passes water that has permeated a reverse osmosis membrane through the demineralization chamber as the water to be treated.

10. The deionized water producing system according to claim 6, wherein the ionic silica concentration of the water to be treated is 150 μg/L or less and the hardness (calcium/magnesium concentration) is 100 μg CaCO3/L or less.

11. The method for operating the deionized water production system according to claim 2, wherein the operation time for each of said water intake and regeneration modes is 2 hours or more.

12. The method for operating the deionized water production system according to claim 2, wherein permeated water that has permeated a reverse osmosis membrane device is passed through the demineralization chamber as the water to be treated.

13. The method for operating the deionized water production system according to claim 2, wherein the ionic silica concentration of the water to be treated is 150 μg/L or less and the hardness (calcium/magnesium concentration) is 100 μg CaCO3/L or less.

14. The deionized water production system according to claim 7, wherein the operation time for each of said water intake and regeneration modes is two hours or more.

15. The deionized water producing system according to claim 7, further comprising a reverse osmosis membrane device which passes water that has permeated a reverse osmosis membrane through the demineralization chamber as the water to be treated.

16. The deionized water producing system according to claim 7, wherein the ionic silica concentration of the water to be treated is 150 μg/L or less and the hardness (calcium/magnesium concentration) is 100 μg CaCO3/L or less.
